(19) United States
(12) Patent Application Publication
(10) Pub. No.: US 2007/0139766 A1
(43) Pub. Date: Jun. 21, 2007

(54) High contrast front projection screen

(76) Inventors: Marc D. Radcliffe, Newport, MN (US); Nirmal Manoj, St. Paul, MN (US)

Correspondence Address: 3M INNOVATIVE PROPERTIES COMPANY, PO BOX 33427, ST. PAUL, MN, 55133-3427, US

(21) Appl. No.: 11/312,939

(22) Filed: Dec. 20, 2005

(51) Int. Cl. G03B 21/60

(52) U.S. Cl. 359/459

(57) ABSTRACT

A front projection screen and a projection system incorporating same are disclosed. The front projection screen includes a plurality of cholesteric liquid crystal layers and one or more retarder layers. Each cholesteric liquid crystal layer has a reflectance curve characterized by a reflectance peak and a reflectance full width at half maximum. The reflectance peaks of at least two cholesteric liquid crystal layers in the plurality of cholesteric liquid crystal layers are located at different wavelengths. A retardance full width at half maximum of a first retarder layer in the one or more retarder layers encloses the reflectance full width at half maxima of two or more cholesteric liquid crystal layers in the plurality of cholesteric liquid crystal layers.

### FIELD OF THE INVENTION

This invention generally relates to projection screens and projection systems incorporating same. The invention is particularly applicable to front projection screens with high ambient light rejection.

### BACKGROUND

A front projection screen is generally designed to reflect an image projected by a projector onto the front side of the screen into a viewing space where the projector and the viewing space are both located on the front side of the screen. Typical screen characteristics used to describe a screen's performance include gain, viewing angle, resolution, contrast, color fidelity and the like. It is generally desirable to have a front projection screen that has high resolution, high contrast and a large gain. It is also desirable that the screen spread the light over a large viewing space. Unfortunately, as one screen characteristic is improved, one or more other screen characteristics often degrade. For example, in order to increase the screen gain, one must often decrease the contrast and/or viewing angle of the screen. As a result, certain tradeoffs are made in screen characteristics and performance in order to optimize the screen's overall performance in a desired projection display application.

Front projection screens reflect substantially all of the light incident on them, i.e., they reflect ambient light as well as light from an image projecting source. Because a portion of the ambient light is reflected towards the viewing space, the image contrast or the apparent brightness of the image is often reduced, particularly in areas with relatively high levels of ambient light.

### SUMMARY OF THE INVENTION

Generally, the present invention relates to projection screens. The present invention also relates to projection screens employed in projection systems.

In one embodiment of the invention, a front projection screen includes a plurality of cholesteric liquid crystal layers and one or more retarder layers. Each cholesteric liquid crystal layer has a reflectance curve characterized by a reflectance peak and a reflectance full width at half maximum. The reflectance peaks of at least two cholesteric liquid crystal layers in the plurality of cholesteric liquid crystal layers are located at different wavelengths. A retardance full width at half maximum of a first retarder layer in the one or more retarder layers encloses the reflectance full width at half maxima of two or more cholesteric liquid crystal layers in the plurality of cholesteric liquid crystal layers.

In another embodiment of the invention, a front projection screen includes a plurality of cholesteric liquid crystal layers and one or more retarder layers. A first cholesteric liquid crystal layer in the plurality of cholesteric liquid crystal layers has a first reflectance peak at an m^{th} order half-wave retardance peak of a retarder layer in the one or more retarder layers. A second cholesteric liquid crystal layer in the plurality of cholesteric liquid crystal layers has a second reflectance peak at an n^{th} order half-wave retardance peak of a retarder layer in the one or more retarder layers. The first reflectance peak is at a different wavelength than the second reflectance peak. n is different than m.

In another embodiment of the invention, a front projection screen includes a plurality of cholesteric liquid crystal layers and one or more retarder layer. Each cholesteric liquid crystal layer has a reflectance curve characterized by a reflectance peak and a reflectance full width at half maximum. At least one of the one or more retarder layers has a plurality of half-wave retardance peaks within the reflectance full width at half maximum of a cholesteric liquid crystal layer in the plurality of cholesteric liquid crystal layers.

In another embodiment of the invention, a front projection screen includes at least three groups of optical layers. Each group includes a retarder layer disposed between two cholesteric liquid crystal layers having a same handed-ness. Each group reflects light in a wavelength region in which the other groups transmit light.

In another embodiment of the invention, a front projection screen includes at least three groups of optical layers. Each group reflects light in a wavelength region in which the other groups transmit light. Each of at least two groups include a retarder layer disposed between two cholesteric liquid crystal layers having a same handed-ness. At least one group includes a multilayer optical film that includes alternating first and second layers. The multilayer optical film reflects light by optical interference.

In another embodiment of the invention, a front projection screen includes a first group of optical layers that substantially reflects light in a first wavelength region in the visible and substantially transmits light elsewhere in the visible. The front projection screen further includes a second group of optical layers that substantially reflects light in a second wavelength region in the visible and substantially transmits light elsewhere in the visible. The second region is different than the first region. Each of the first and second groups includes a retarder layer disposed between two cholesteric liquid crystal layers that have a same handed-ness. The front projection screen further includes a colored reflective layer that substantially reflects light in a third wavelength region in the visible and substantially absorbs light elsewhere in the visible. The third region is different than the first and the second regions.

### BRIEF DESCRIPTION OF DRAWINGS

The invention may be more completely understood and appreciated in consideration of the following detailed description of various embodiments of the invention in connection with the accompanying drawings, in which:

FIG. 1 shows a three-dimensional schematic of a set up for determining the fast and slow axes of a retarder;

FIG. 2 shows a schematic retardance profile of a retarder;

FIG. 3 shows a schematic side-view of an optical stack in accordance with one embodiment of the invention;

FIG. 4 shows a schematic side-view of an optical stack in accordance with another embodiment of the invention;

FIG. 5 shows a schematic side-view of a front projection screen in accordance with one embodiment of the invention;

FIG. 6 shows a schematic side-view of a front projection screen in accordance with another embodiment of the invention;

FIG. 7 shows a schematic side-view of a front projection screen in accordance with another embodiment of the invention;

FIG. 8 schematically shows the relationship between the retardance profile of a retarder layer and the reflectance curves of cholesteric liquid crystal (CLC) layers employed in a front projection screen in accordance with one embodiment of the invention;

FIG. 9 schematically shows the relationship between the retardance profile of a retarder layer and the reflectance curves of cholesteric liquid crystal (CLC) layers employed in a front projection screen in accordance with another embodiment of the invention;

FIG. 10 schematically shows the relationship between the retardance profile of a retarder layer and the reflectance curves of cholesteric liquid crystal (CLC) layers employed in a front projection screen in accordance with another embodiment of the invention;

FIG. 11 schematically shows the relationship between the retardance profile of a retarder layer and the reflectance curves of cholesteric liquid crystal (CLC) layers employed in a front projection screen in accordance with another embodiment of the invention;

FIG. 12 shows a schematic side-view of a projection display system in accordance with one embodiment of the invention;

FIG. 13 schematically shows the emission spectrum of light projected by a projector and the reflectance curves of CLC layers employed in a front projection screen in accordance with one embodiment of the invention;

FIG. 14 shows a schematic side-view of a front projection screen in accordance with one embodiment of the invention;

FIG. 15 shows a schematic side-view of a front projection screen in accordance with another embodiment of the invention;

FIG. 16 shows a schematic side-view of a front projection screen in accordance with another embodiment of the invention; and

FIG. 17 shows the reflectance curve of a front projection screen fabricated in accordance with one embodiment of the invention, and the retardance profile of a retarder layer employed in the screen.

### DETAILED DESCRIPTION

The present invention generally relates to front projection screens and front projection systems incorporating a front projection screen. The invention is particularly applicable to a front projection screen where it is desirable to display a projected image with high contrast and brightness.

In the specification, a same reference numeral used in multiple figures refers to the same or similar elements having the same or similar properties and functionalities.

The present invention describes a front projection screen that utilizes highly reflective cholesteric liquid crystal films combined with one or more retarder films. One advantage of the screen of the invention is efficient reflection of light incident onto the screen from a projector which leads to displayed images having high brightness. Another advantage of the invention is substantial absorption of ambient light by the screen leading to displayed images having high contrast.

As used herein, the terms “specular reflection” and “specular reflectance” refer to the reflection of an incident collimated light into a reflected light cone with a relatively narrow cone angle, where the full cone angle is typically about 10 degrees or less, more typically about 5 degrees or less, and even more typically about 2 degrees or less. The terms “diffuse reflection” or “diffuse reflectance” refer to the reflection of an incident collimated light outside the specular full cone angle. The terms “total reflectance” or “total reflection” refer to the combined reflectance of all light from a surface. Thus, for example, total reflection is the sum of specular and diffuse reflections.

Similarly, the terms “specular transmission” and “specular transmittance” refer to the transmission of rays into a transmitted light cone with a relatively narrow full cone angle, where the full cone angle is typically about 10 degrees or less, more typically about 5 degrees or less, and even more typically about 2 degrees or less. The terms “diffuse transmission” and “diffuse transmittance” refer to rays that are transmitted outside the specular cone. The terms “total transmission” or “total transmittance” refer to the combined transmission of all light through an optical body. Thus, for example, total transmission is the sum of specular and diffuse transmissions.

The present invention discloses a front projection screen where the reflection spectrum of the screen substantially matches that of the image producing projector. Accordingly, one advantage of the present invention is that a projected image can be displayed with high brightness and color fidelity.

The present invention further discloses a front projection screen that absorbs a substantial amount of the ambient light. In a typical setting, ambient light can include light from various artificial light sources such as a mercury arc light source, an incandescent light source, a fluorescent light source, or a light emitting diode (LED) light source, or a natural light source such as the sun. The present invention discloses a front projection screen that absorbs a substantial amount of the ambient light that lies outside the wavelength ranges emitted by a projector. Thus, another advantage of the present invention is that a projected image can be displayed with high contrast even in the presence of high ambient light.

The present invention discloses a front projection screen that includes cholesteric liquid crystal (CLC) layers. Examples of references discussing CLCs in detail include De Gennes, Prost, “The Physics of Liquid Crystals,” Oxford University Press 1995, ISBN 0198517858 and Collings, Hird, “Introduction to Liquid Crystals: Chemistry and Physics,” Taylor & Francis 1997, ISBN 074840483X. In summary, CLCs have a liquid crystal phase or a mesophase in which the director (that is, the unit vector in the direction of average local molecular alignment) of the liquid crystal rotates in a helical fashion along the dimension perpendicular to the director. Cholesteric liquid crystals are also referred to as chiral nematic liquid crystals. The pitch of a cholesteric liquid crystal compound is the distance (in a direction perpendicular to the director) that it takes for the director to rotate through 360°. This distance is typically 100 nm, although in some cases the pitch can be larger or smaller than 100 nm.

The pitch of a cholesteric liquid crystal compound can typically be altered by mixing or otherwise combining (e.g., by copolymerization) a chiral compound (e.g., a cholesteric liquid crystal compound) with a nematic liquid crystal compound, where a chiral compound refers to a compound that does not possess an internal plane of symmetry. In other words, a chiral compound or object is one that is not superimposable on its mirror image. An example of a chiral object is a coiled spring. An achiral compound, on the other hand, is a compound that has at least one internal plane of symmetry and, therefore, can be superimposed on its mirror image.

The pitch of a cholesteric liquid crystal compound generally depends on a number of factors such as the relative weight ratio of the chiral compound and the nematic liquid crystal compound. The pitch is generally selected to be on the order of the wavelength of light of interest. The helical twist of the director results in a spatially periodic variation in the dielectric tensor, which in turn gives rise to wavelength selective reflection of light by a CLC. In some applications such as display systems, the pitch can be chosen such that the selective reflection is peaked in the visible, such as in the red, green, or blue regions of the electromagnetic spectrum.

One characteristic of CLCs is that they circularly polarize an incident light beam upon reflection. If a light beam has two orthogonal polarization directions which vary in phase by 90°, the beam is said to be elliptically or circularly polarized. Circular polarization occurs when the magnitude of the two oscillations are equal (i.e., the tip of the electric field vector moves in a circle). In general, a right-handed CLC reflects right-handed circularly polarized light within a reflection band and a left-handed CLC reflects left-handed circularly polarized light within a reflection band. The peak of the reflection band, λₚ, is given by:
λₚ=nP (1)
where n and P are the average index and pitch of the CLC, respectively. The reflectance full width at half maximum (FWHM) or the bandwidth, Δλ, of the CLC is approximately given by:
Δλ=ΔnP (2)
where Δn is the birefringence of the CLC.

The present invention also discloses front projection screens that include one or more retarder films. A retarder film is generally made of a birefringent material that can change the phase of an incident polarized light beam as it travels through the thickness of the retarder. Accordingly, a retarder film can shift the phase of light polarized in one direction relative to the phase of light polarized in a perpendicular direction. By controlling the magnitude of birefringence in a retarder film a desired phase shift (or retardance) can be introduced in a light beam that is transmitted by the retarder film.

A retarder film can change the polarization of an incident light beam. For example, a quarter-wave retarder can convert linearly polarized light to circularly polarized light by virtue of introducing a 90° phase shift. As another example, a half-wave retarder can introduce a phase shift of 180°. Thus, a half-wave retarder can be used to, for example, convert a right-handed circularly polarized light to a left-handed circularly polarized light.

The retardance or retardation angle, δ, of a retarder film is given by:

$$δ = \frac{t ( Δ {n}_{r} ) ( 2 π )}{λ} \qquad ( 3 )$$

where t is the film thickness, Δnᵣ is the film birefringence and λ is wavelength.

In general, a retarder has a fast axis which is the direction with the smaller index of refraction, and a slow axis which is the direction with the larger index of refraction. The fast axis is normal to the slow axis.

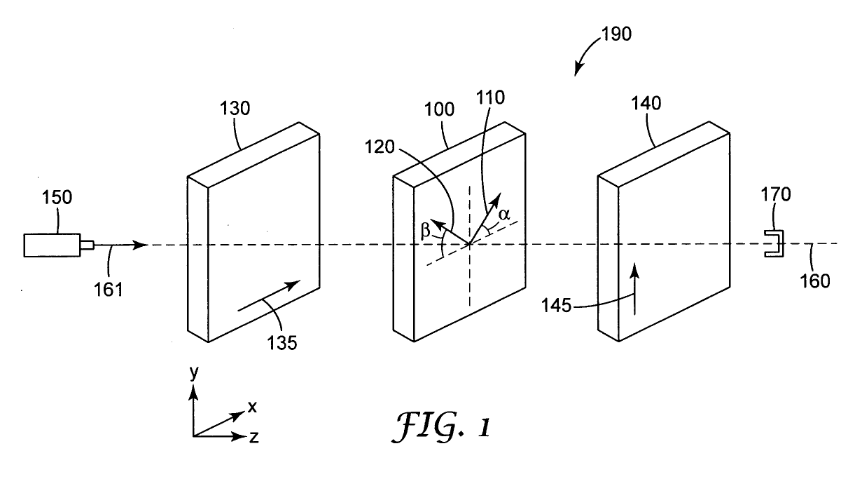

FIG. 1 illustrates a three-dimensional schematic of a set up 190 for determining the fast and slow axes of a retarder. Set up 190 has an optical axis 160 oriented along the z-direction and includes a light source 150 that emits unpolarized white light 161 along optical axis 160, a linear polarizer 130 having a polarization axis 135 oriented along the x-direction, a linear polarizer 140 having a polarization axis 145 oriented along the y-direction, a retarder film 100 positioned between polarizers 130 and 140 and having a fast axis 110 and a slow axis 120, and an optical detector 170 for measuring light intensity. Fast and slow axes 110 and 120 make angles α and β with the x-direction, respectively, where α+β is 90°. Linear polarizers 130 and 140 are crossed meaning that polarization axes 135 and 145 are normal to one another.

One way to determine the orientations of axes 110 and 120 is to rotate retarder 100 in the xy-plane about the z-axis until optical detector 170 measures a minimum optical intensity, in which case, one of the two angles α and β is zero and the other angle is 90°. Alternatively, retarder 100 may be rotated in the xy-plane about the z-axis until optical detector 170 measures a maximum optical intensity, in which case, angles α and β are both 45°.

The half-wave peaks of retarder film 100 may be determined by using a spectrophotometer to measure the optical transmission of the assembly of linear polarizer 130, retarder 100, and linear polzarizer 140 for incident unpolarized light as a function of wavelength. In the assembly, polarizers 130 and 140 are crossed and retarder film 100 is oriented so that its fast axis 110 makes a 45° angle with polarization axes 135 and 145.

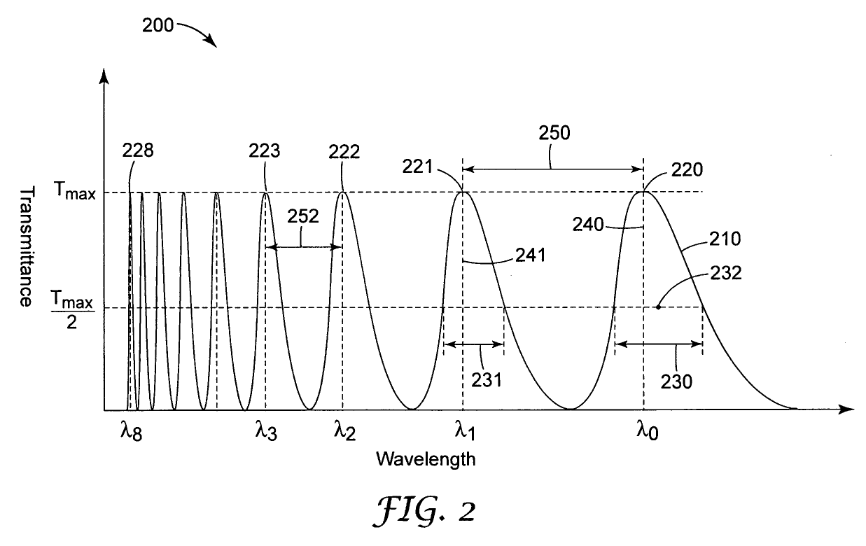

FIG. 2 shows a schematic plot 200 of a typical retardance profile 210 measured by the spectrophotometer. The vertical and horizontal axes in plot 200 are transmittance and wavelength, respectively. Retardance profile 210 has a plurality of peaks, such as peaks 220 and 221. Each peak in the retardance profile 210 corresponds to a half-wave point. For example, peak 220 occurs at wavelength λₒ, meaning that the retarder is a half-wave retarder at λₒ. First peak 220 is often referred to as the zeroth order half-wave peak of the retarder. Retardance profile 210 has higher order half-wave peaks located at shorter wavelengths such as a 1^{st} order half-wave peak 221 located at wavelength λ₁, a 2^{nd} order half-wave peak 222 located at wavelength λ₂, a 3^{rd} order half-wave peak 223 located at wavelength λ₃, and an 8^{th} order half-wave peak 228 located at wavelength λ₈.

Associated with each peak is a retardance full width at half maximum (FWHM). For example, retardance FWHM 230 is associated with peak 220 and retardance FWHM 231 is associated with peak 221. Generally, the size of FWHM decreases as the order of the peak increases. In other words, a half-wave peak at a shorter wavelength generally has a smaller FWHM than a half-wave peak at a longer wavelength.

The local shape of retardance profile 210 at a given peak is generally asymmetric. For example, the local shape of retardance profile 210 at peak 220 is asymmetric with respect to line 240 that passes through peak 220, meaning that, for example, midpoint 232 of FWHM 230 does not lie on line 240. Similarly, the local shape of retardance profile 210 at peak 221 is asymmetric with respect to line 241 that passes through peak 221. The degree of local asymmetry may vary depending on the type of retarder used. Some retarders can have symmetric or almost symmetric local shapes.

The separation between adjacent peaks generally decreases with decreasing wavelength. For example, separation 252 which is λ₂-λ₃ is generally smaller than separation 250 which is λₒ-λ₁. The separation between adjacent peaks at sufficiently high order half-wave peaks can become small enough that a measuring instrument such as a spectrophotometer may not be able to resolve the separation.

FIG. 3 shows a schematic side-view of an optical stack 1100 in accordance with one embodiment of the invention. Optical stack 1100 includes a retarder layer 1150 disposed between CLC layers 1110A and 1110B. The two CLC layers have the same handedness. For exemplary purposes, the operation of optical stack 1100 is described assuming right-handed CLC layers 1110A and 1110B, although it will be appreciated that the two layers can be left-handed cholesteric liquid crystal layers. Furthermore, for ease of illustration and exemplary purposes, layers 1110A, 1150, and 1110B are shown as spaced-apart layers. In general, there may or may not be a separation between the layers in optical stack 1100.

CLC layers 1110A and 1110B substantially reflect right-handed circularly polarized light at a wavelength λ₁ and substantially transmit left-handed circularly polarized light at the same wavelength. Retarder layer 1150 is a half-wave retarder at λ₁ and as such, can change the handedness of a circularly polarized light on transmission. Optical stack 1100 is capable of substantially reflecting an incident light at wavelength λ₁ as described below.

An incident light ray 1105 at wavelength λ₁ can be decomposed into a right-handed circularly polarized light ray 1101 and a left-handed circularly polarized light ray 1102 where the two polarization states are orthogonal to each other. Light ray 1101 is substantially reflected by CLC layer 1110A producing a right-handed circularly polarized reflected light ray 1101E. Light ray 1102, on the other hand, is substantially transmitted by CLC layer 1110A producing a left-handed circularly polarized transmitted light ray 1102A. Retarder film 1150 shifts the phase of light ray 1102A on transmission and produces a right-handed circularly polarized light ray 1102B. Light ray 1102B is substantially reflected by CLC layer 1110B producing a right-handed circularly polarized reflected light ray 1102C. Retarder film 1150 shifts the phase of light ray 1102C on transmission and produces a left-handed circularly polarized light ray 1102D. Light ray 1102D is substantially transmitted by CLC layer 1110A producing a left-handed circularly polarized light ray 1102E. Accordingly, optical stack 1100 substantially reflects incident light ray 1105.

Wavelength λ₁ can be any wavelength that may be desirable in an application. In one embodiment of the invention, wavelength λ₁ is in the visible region of the electromagnetic spectrum. For example, wavelength λ₁ can be a primary color such as red, green, or blue. In some applications, optical stack 1100 is illuminated by light projected by a projector or a projection system, in which case, λ₁ can be the wavelength of a light ray emitted by the projector or the projection system.

Optical stack 1100 has been described as being capable of reflecting light at a single wavelength λ₁. In general, optical stack 1100 can be capable of reflecting light at a plurality of wavelengths such as a plurality of discrete wavelengths. In some embodiments of the invention, optical stack 1100 is capable of reflecting light at a range of wavelengths Δλ₁ where Δλ₁ can, for example, be a range of wavelengths in the visible such as a range in the blue, green, or red region of the electromagnetic spectrum.

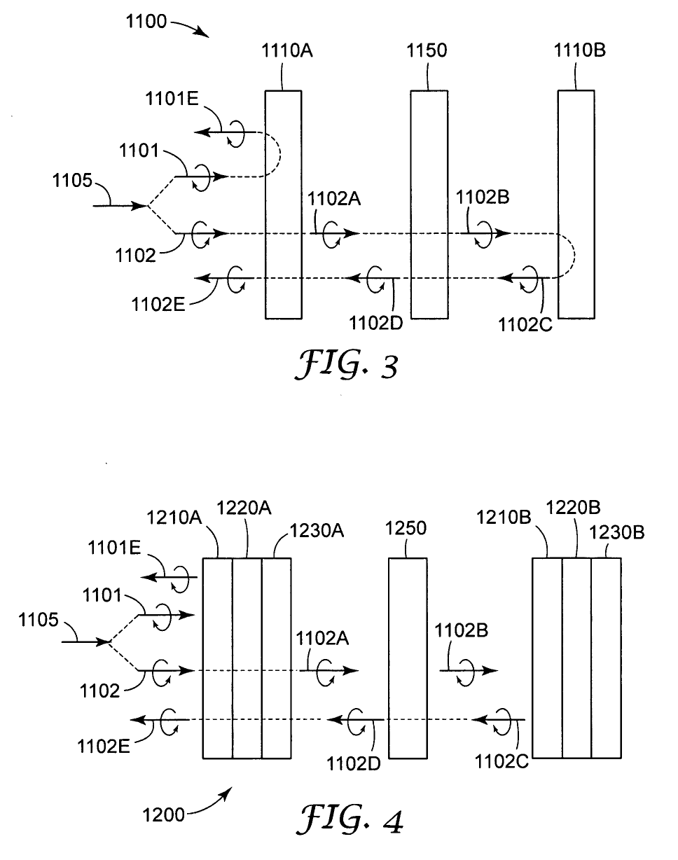

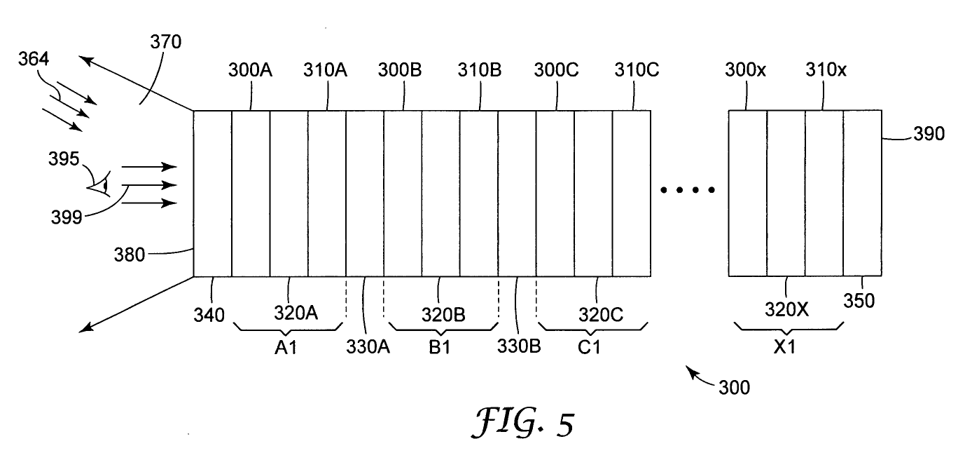

FIG. 4 shows a schematic side-view of an optical stack 1200 in accordance with another embodiment of the invention. Optical stack 1200 includes a retarder layer 1250 disposed between CLC layers 1210A, 1220A, and 1230A, and CLC layers 1210B, 1220B, and 1230B. The six CLC layers in optical stack 1200 have the same handedness. For exemplary purposes, the operation of optical stack 1200 is described assuming right-handed CLC layers in the stack, although it will be appreciated that the CLC layers can be left-handed cholesteric liquid crystal layers. Furthermore, for ease of illustration and without any loss of generality retarder layer 1250 is shown to be separated from CLC layers 1210A, 1220A, and 1230A, and CLC layers 1210B, 1220B, and 1230B. In general, there may or may not be a separation between two or more layers in optical stack 1200.

In optical stack 1200, each of CLC layers 1210A and 1210B substantially reflects right-handed circularly polarized light at a wavelength λ₁ₐ and substantially transmits left-handed circularly polarized light at λ₁ₐ; each of CLC layers 1220A and 1220B substantially reflects right-handed circularly polarized light at a wavelength λ₂ₐ and substantially transmits left-handed circularly polarized light at λ₂ₐ where λ₂ₐ is different from λ₁ₐ; and each of CLC layers 1230A and 1230B substantially reflects right-handed circularly polarized light at a wavelength λ₃ₐ and substantially transmits left-handed circularly polarized light at λ₃ₐ where λ₃ₐ is different from λ₁ₐ and λ₂ₐ.

Furthermore, each of CLC layers 1210A and 1210B substantially transmits light at wavelengths λ₂ₐ and λ₃ₐ, each of CLC layers 1220A and 1220B substantially transmits light at wavelengths λ₁ₐ and λ₃ₐ, and each of CLC layers 1230A and 1230B substantially transmits light at wavelengths λ₁ₐ and λ₂ₐ.

Retarder layer 1250 is substantially a half-wave retarder at all three wavelengths λ₁ₐ, λ₂ₐ, and λ₃ₐ and, therefore, can change the handedness of a circularly polarized light on transmission at any of the three wavelengths. Optical stack 1200 functions similarly to optical stack 1100 except that optical stack 1200 is capable of substantially reflecting an incident light at three wavelengths λ₁ₐ, λ₂ₐ, and λ₃ₐ. In particular, the combination of CLC layers 1210A and 1210B and retarder layer 1250 (the first combination) is capable of substantially reflecting light at wavelength λ₁ₐ; the combination of CLC layers 1220A and 1220B and retarder layer 1250 (the second combination) is capable of substantially reflecting light at wavelength λ₂ₐ; and the combination of CLC layers 1230A and 1230B and retarder layer 1250 (the third combination) is capable of substantially reflecting light at wavelength λ₃ₐ.

The first, second, and third combinations in optical stack 1200 have been described as being capable of reflecting light at discrete wavelengths λ₁ₐ, λ₂ₐ, and λ₃ₐ, respectively. In general, each of the first, second, and third combinations can be capable of reflecting light at a plurality of wavelengths such as a plurality of discrete wavelengths. In some embodiments of the invention, the first combination in optical stack 1200 is capable of reflecting light at a range of wavelengths Δλ₁ₐ where Δλ₁ₐ can, for example, be a range of wavelengths in the visible such as a range in the blue region of the electromagnetic spectrum. Similarly, in some embodiments of the invention, the second combination in optical stack 1200 is capable of reflecting light at a range of wavelengths Δλ₂ₐ where Δλ₂ₐ can, for example, be a range of wavelengths in the visible such as a range in the green region of the electromagnetic spectrum. Furthermore, in some embodiments of the invention, the third combination in optical stack 1200 is capable of reflecting light at a range of wavelengths Δλ₃ₐ where Δλ₃ₐ can, for example, be a range of wavelengths in the visible such as a range in the red region of the electromagnetic spectrum.

In one embodiment of the invention, a combination substantially transmits light in wavelength regions where the other combinations substantially reflect light. For example, the first combination substantially transmits light in ranges Δλ₂ₐ and Δλ₃ₐ; the second combination substantially transmits light in ranges Δλ₁ₐ and Δλ₃ₐ; and the third combination substantially transmits light in ranges Δλ₁ₐ and Δλ₂ₐ.

In one embodiment of the invention, there is no overlap between wavelength ranges Δλ₁ₐ, Δλ₂ₐ, and Δλ₃ₐ. In some applications, there may be an overlap between two or more of the wavelength ranges. In some applications, the combination of the wavelength ranges may include a fraction of the visible region. In some other applications, the combination of the wavelength ranges may extend the entire visible region of the electromagnetic spectrum.

FIG. 5 illustrates a schematic side-view of a front projection screen 300 in accordance with one embodiment of the invention. Screen 300 has a viewing side 380 and a back side 390 and includes a plurality of optical stacks including optical stacks A1, B1, C1, and X1 where each optical stack is similar to optical stack 1100 described in reference to FIG. 3. In particular, optical stack A1 includes retarder layer 320A disposed between CLC layers 300A and 310A, optical stack B1 includes retarder layer 320B disposed between CLC layers 300B and 310B, optical stack C1 includes retarder layer 320C disposed between CLC layers 300C and 310C, and optical stack X1 includes retarder layer 320X disposed between CLC layers 300X and 310X.

According to one embodiment of the invention, each optical stack in screen 300 reflects light at a wavelength and transmits light at other wavelengths. For example, optical stack A1 reflects light at a wavelength λ_{A1} and transmits light at other wavelengths; optical stack B1 reflects light at a wavelength λ_{B1}, where λ_{B1} is different from wavelength Δ_{A1}, and transmits light at other wavelengths; optical stack C1 reflects light at a wavelength λ_{C1}, where λ_{C1} is different from wavelengths λ_{A1} and λ_{B1}, and transmits light at other wavelengths, and optical stack X1 reflects light at a wavelength λ_{X1}, where λ_{X1} is different from wavelengths λ_{A1}, λ_{B1}, and λ_{C1}, and transmits light at other wavelengths. Similar to the discussion in reference to optical stack 1100, each of the wavelengths λ_{A1}, λ_{B1}, λ_{C1}, and λ_{X1} can be a wavelength in the visible region of the spectrum.

Although each optical stack in screen 300 is described as being capable of reflecting light at a single wavelength, in general, each optical stack can be capable of reflecting light at a plurality of wavelengths such as a plurality of discrete wavelengths. In some embodiments of the invention, optical stack A1 is capable of reflecting light at a range of wavelengths Δλ_{A1}, optical stack B1 is capable of reflecting light at a range of wavelengths Δλ_{B1}, optical stack C1 is capable of reflecting light at a range of wavelengths Δλ_{C1}, and optical stack X1 is capable of reflecting light at a range of wavelengths Δλ_{X1}, where one or more of the wavelength ranges Δλ_{A1}, Δλ_{B1}, Δλ_{C1}, and Δλ_{A1} can, for example, be a range of wavelengths in the visible region of the electromagnetic spectrum.

According to one embodiment of the invention, each optical stack in screen 300 is substantially reflective in a wavelength region and substantially transmissive in each wavelength region in which another stack is substantially reflective.

Although screen 300 is shown to have four optical stacks, in general, screen 300 can have more or fewer number of optical stacks. In particular, according to one embodiment of the invention, screen 300 includes three optical stacks A1, B1, and C1, where optical stack A1 substantially reflects light within the wavelength range Δλ_{A1} and substantially transmits light within a different wavelength range Δλ_{A2}; optical stack B1 substantially reflects light within the wavelength range Δλ_{B1} and substantially transmits light within a different wavelength range Δλ_{B2}; and optical stack C1 substantially reflects light within the wavelength range Δλ_{C1} and substantially transmits light within a different wavelength range Δλ_{C2}. Ranges Δλ_{A1}, Δλ_{B1}, and Δλ_{C1} can be different wavelength ranges, although there can be one or more overlapping regions between the ranges.

According to one embodiment of the invention, Δλ_{A2} includes ranges Δλ_{B1} and Δλ_{C1}, Δλ_{B2} includes ranges Δλ_{A1} and Δλ_{C1}, and Δλ_{C2} includes ranges Δλ_{A1} and Δλ_{B1}.

In one embodiment of the invention, Δλ_{A1} is a wavelength range in the visible region of the spectrum that includes a first primary color such a blue color, Δλ_{B1} is a wavelength range in the visible region of the spectrum that includes a second primary color such a green color, and Δλ_{C1} is a wavelength range in the visible region of the spectrum that includes a third primary color such a red color. Furthermore, optical stack A1 substantially reflects light within Δλ_{A1} and substantially transmits light elsewhere in the visible; optical stack B1 substantially reflects light within Δλ_{B1} and substantially transmits light elsewhere in the visible; and optical stack C1 substantially reflects light within Δλ_{C1} and substantially transmits light elsewhere in the visible.

Each cholesteric liquid crystal layer in screen 300 has a reflectance curve that is characterized by a reflectance peak and a reflectance full width at half maximum (FWHM). Furthermore, each retarder layer in screen 300 has a retardance profile characterized by a plurality of half-wave peaks where each half-wave peak has an associated retardance full width at half maximum (FWHM).

Screen 300 further includes optional optical buffer layers, such as layers 330A and 330B placed between adjacent cholesteric liquid crystal layers. For example, buffer layer 330A is placed between cholesteric liquid crystal layers 310A and 300B. The buffer layers can be advantageous in, for example, preventing a layer from adversely affecting the performance of an adjacent layer by, for example, partially diffusing into the adjacent layer during the manufacturing of the screen. As another example, the buffer layers may have alignment properties to assist in orienting liquid crystal molecules in the cholesteric liquid crystal layers. The buffer layers may have adhesive properties for attaching adjacent optical stacks.

One or more of the buffer layers and/or CLC layers can be optically diffusive by, for example, dispersing small particles in a host material where the index of refraction of the particles is different than the index of refraction of the host material. Furthermore, one or more of the buffer layers may function as a color filter to, for example, improve color purity of an image displayed by the screen.

Screen 300 further includes one or more diffuser layers such as diffuser layer 340. Diffuser layer 340 can assist in scattering light into a viewing space 370 which may include one or more viewers such as a viewer 395. Diffuser layer 340 can include structures (not shown in FIG. 5) on a side of the layer such as the viewing side 380 for selectively redirecting or further scattering light towards viewing space 370.

Screen 300 further includes a light absorbing layer 350 for increasing screen contrast by absorbing non-imaging or otherwise undesirable light such as ambient light.

Screen 300 may further include other layers not explicitly shown in FIG. 3. Examples include alignment layers for aligning liquid crystal molecules, antireflection coatings, hard coat layers, anti-smudge layers, UV absorbing protective layers, adhesive layers for attaching adjacent layers, one or more backing layers for providing support and/or a desirable shape to the screen, one or more notch filter layers, and the like.

In one embodiment of the invention, a projection system illuminates screen 300 with light 399 from the viewing side of the screen. The screen includes optical stacks A1, B1, and C1 and light absorbing layer 350. Light 399 includes wavelengths that are substantially limited to ranges Δλ_{A1}, Δλ_{B1}, and Δλ_{C1}. Screen 300 substantially reflects light 399 while absorbing layer 350 substantially absorbs any ambient light 364 that falls outside the three wavelength ranges.

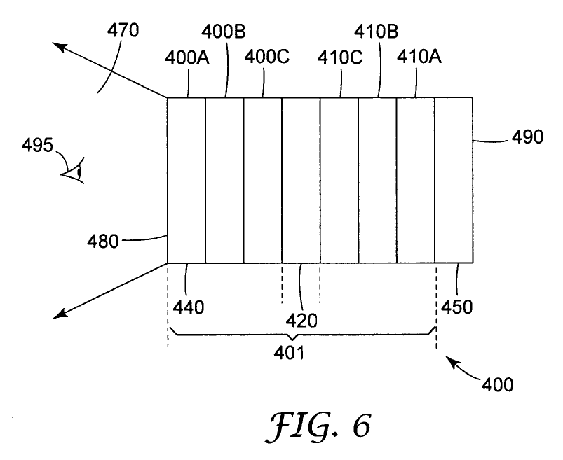

FIG. 6 illustrates a schematic side-view of a front projection screen 400 in accordance with one embodiment of the invention. Screen 400 has a viewing side 480 and a back side 490 and includes an optical stack 401 similar to optical stack 1200 described in reference to FIG. 4. In particular, optical stack 401 includes CLC layers 400A-400C and 410A-410C, and a retarder layer 420 disposed between CLC layers 400C and 410C.

Optical stack 401 is capable of substantially reflecting light at wavelengths λ_{Y1}, λ_{Y2}, and λ_{Y3}. In particular, the combination of CLC layers 400A and 410A and retarder layer 420 (the Y1 combination) is capable of substantially reflecting light at wavelength λ_{Y1}, the combination of CLC layers 400B and 410B and retarder layer 420 (the Y2 combination) is capable of substantially reflecting light at wavelength λ_{Y2}, and the combination of CLC layers 400C and 410C and retarder layer 420 (the Y3 combination) is capable of substantially reflecting light at wavelength λ_{Y3}.

Wavelengths λ_{Y1}, λ_{Y2}, and λ_{Y3} can be any wavelengths that may be desirable in an application. In one embodiment of the invention, wavelengths λ_{Y1}, λ_{Y2}, and λ_{Y3} are located in the visible region of the electromagnetic spectrum. For example, wavelengths λ_{Y1}, λ_{Y2}, and λ_{Y3} can be primary colors blue, red, and green, respectively.

The Y1, Y2, and Y3 combinations in optical stack 401 have been described as being capable of reflecting light at discrete wavelengths λ_{Y1}, λ_{Y2}, and λ_{Y3}, respectively. In general, each of the Y1, Y2, and Y3 combinations can be capable of reflecting light at a plurality of wavelengths such as a plurality of discrete wavelengths. In some embodiments of the invention, the Y1 combination in screen 400 is capable of substantially reflecting light in a wavelength range Δλ_{Y1} and substantially transmitting light in a different wavelength range Δλ_{Z1}, the Y2 combination is capable of substantially reflecting light in a wavelength range Δλ_{Y2} and substantially transmitting light in a different wavelength range Δλ_{Z2}, and the Y3 combination is capable of substantially reflecting light in a wavelength range Δλ_{Y3} and substantially transmitting light in a different wavelength range Δλ_{Z3}. Furthermore, wavelength range Δλ_{Z1} preferably includes ranges Δλ_{Y2} and Δλ_{Y3}, wavelength range Δλ_{Z2} preferably includes ranges Δλ_{Y1} and Δλ_{Y3}, and wavelength range Δλ_{Z3} preferably includes ranges Δλ_{Y1} and Δλ_{Y2}.

In one embodiment of the invention, Δλ_{Y1}, Δλ_{Y2}, and Δλ_{Y3} are ranges of wavelength in the visible such as ranges in the blue, green, and red regions of the electromagnetic spectrum, respectively. Furthermore, optical stack 401 substantially reflects light within ranges Δλ_{Y1}, Δλ_{Y2}, and Δλ_{Y3} and substantially transmits light elsewhere in the visible.

In one embodiment of the invention, Δλ_{Y1} is a wavelength range in the visible region of the spectrum that includes a first primary color such as a blue color, Δλ_{Y2} is a wavelength range in the visible region of the spectrum that includes a second primary color such as a green color, and Δλ_{Y3} is a wavelength range in the visible region of the spectrum that includes a third primary color such as a red color. Furthermore, combination Y1 substantially reflects light within Δλ_{Y1} and substantially transmits light elsewhere in the visible, combination Y2 substantially reflects light within Δλ_{Y2} and substantially transmits light elsewhere in the visible, and combination Y3 substantially reflects light within Δλ_{Y3} and substantially transmits light elsewhere in the visible.

In some embodiments of the invention, the order of CLC layers 400A-400C and/or CLC layers 410A-410C may be reversed or otherwise changed.

Each cholesteric liquid crystal layer in screen 400 has a reflectance curve that is characterized by a reflectance peak and a reflectance full width at half maximum. Furthermore, each retarder layer in screen 400 has a retardance profile characterized by a plurality of half-wave peaks where each half-wave peak has an associated retardance full width at half maximum.

Screen 400 further includes one or more diffuser layers such as diffuser layer 440. Diffuser layer 440 may be used to assist in scattering light in a viewing space 470 which may include one or more viewers such as a viewer 495.

Screen 400 further includes a light absorbing layer 450 for increasing screen contrast by absorbing all or a substantial fraction of ambient light that is not reflected by optical stack 401.

Screen 400 may further include other layers not explicitly shown in FIG. 6. Examples include alignment layers for aligning liquid crystal molecules, antireflection coatings, hard coat layers, anti-smudge layers, UV absorbing protective layers, adhesive layers for attaching adjacent layers, one or more backing layers for providing support and/or a desirable shape to the screen, one or more notch filter layers, and the like.

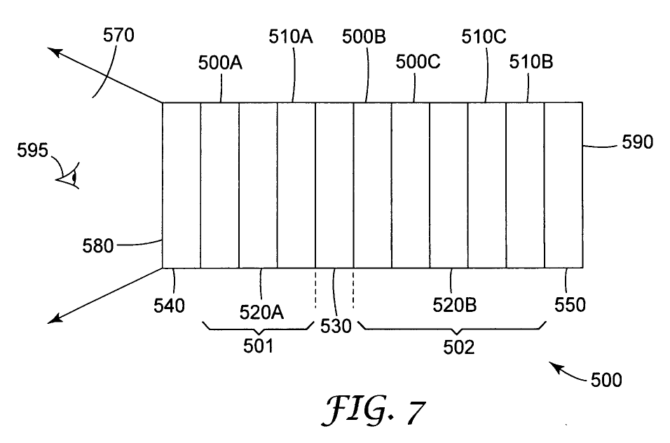

FIG. 7 illustrates a schematic side-view of a front projection screen 500 in accordance with another embodiment of the invention. Screen 500 has a viewing side 580 and a back side 590 and includes optical stacks 501 and 502. Optical stack 501 is similar to optical stack 1100 described in reference to FIG. 3 and includes a retarder layer 520A disposed between CLC layers 500A and 510A. Optical stack 502 is similar to optical stack 1200 described in reference to FIG. 4 and includes CLC layers 500B, 500C, 510B, and 510C. Optical stack 502 further includes a retarder layer 520B disposed between CLC layers 500C and 510C.

The combination of optical stacks 501 and 502 is capable of substantially reflecting light at preferably distinct wavelengths λ_{W1}, λ_{W2}, and λ_{W3}. In particular, optical stack 501 (combination W1) is capable of substantially reflecting light at wavelength λ_{W1}. Furthermore, optical stack 502 is capable of substantially reflecting light at wavelengths λ_{W2} and λ_{W3}.

In one embodiment of the invention, the combination of CLC layers 500B and 510B and retarder layer 520B (the W2 combination) is capable of substantially reflecting light at wavelength λ_{W2}, and the combination of CLC layers 500C and 510C and retarder layer 520B (the W3 combination) is capable of substantially reflecting light at wavelength λ_{W3}.

Wavelengths λ_{W1}, λ_{W2}, and λ_{W3} can be any wavelengths that may be desirable in an application. In one embodiment of the invention, wavelengths λ_{W1}, λ_{W2}, and λ_{W3} are located in the visible region of the electromagnetic spectrum. For example, wavelengths λ_{W1}, λ_{W2}, and λ_{W3} can be primary colors blue, red, and green, respectively.

The W1, W2, and W3 combinations have been described as being capable of reflecting light at discrete wavelengths λ_{W1}, λ_{W2}, and λ_{W3}, respectively. In general, each of the W1, W2, and W3 combinations can be capable of reflecting light at a plurality of wavelengths such as a plurality of discrete wavelengths. In some embodiments of the invention, the W1 combination is capable of substantially reflecting light in a wavelength range Δλ_{W1} and substantially transmitting light in a different wavelength range Δλ_{U1}, the W2 combination is capable of substantially reflecting light in a wavelength range Δλ_{W2} and substantially transmitting light in a different wavelength range Δλ_{U2}, and the W3 combination is capable of substantially reflecting light in a wavelength range Δλ_{W3} and substantially transmitting light in a different wavelength range Δλ_{U3}. Furthermore, wavelength range Δλ_{U1} preferably includes ranges Δλ_{W2} and Δλ_{W3}, wavelength range Δλ_{U2} preferably includes ranges Δλ_{W1} and Δλ_{W3}, and wavelength range Δλ_{U3} preferably includes ranges Δλ_{W1} and Δλ_{W2}.

In one embodiment of the invention, Δλ_{W1}, Δλ_{W2}, and Δλ_{W3} are ranges of wavelength in the visible such as ranges in the blue, green, and red regions of the electromagnetic spectrum, respectively. Furthermore, the combination of optical stacks 501 and 502 substantially reflects light within Δλ_{W1}, Δλ_{W2}, and Δλ_{W3} and substantially transmits light elsewhere in the visible.

In one embodiment of the invention, Δλ_{W1} is a wavelength range in the visible region of the spectrum that includes a first primary color such as a blue color, Δλ_{W2} is a wavelength range in the visible region of the spectrum that includes a second primary color such as a green color, and Δλ_{W3} is a wavelength range in the visible region of the spectrum that includes a third primary color such as a red color. Furthermore, combination W1 substantially reflects light within Δλ_{W1} and substantially transmits light elsewhere in the visible, combination W2 substantially reflects light within Δλ_{W2} and substantially transmits light elsewhere in the visible, and combination W3 substantially reflects light within Δλ_{W3} and substantially transmits light elsewhere in the visible.

In some embodiments of the invention, the order of CLC layers 500B and 500C, and/or layers 510B and 510C may be reversed or otherwise changed. Furthermore, the order of optical stacks 501 and 502 may be reversed or otherwise changed.

Each cholesteric liquid crystal layer in screen 500 has a reflectance curve that is characterized by a reflectance peak and a reflectance full width at half maximum. Furthermore, each retarder layer in screen 500 has a retardance profile characterized by a plurality of half-wave peaks where each half-wave peak has an associated retardance full width at half maximum.

Screen 500 further includes optional optical buffer layers, such as buffer layer 530 placed between adjacent cholesteric liquid crystal layers 510A and 500B. The buffer layers can be advantageous in, for example, preventing a layer from adversely affecting the performance of an adjacent layer by, for example, partially diffusing into the adjacent layer during the manufacturing of the screen. As another example, the buffer layers may have alignment properties to assist in orienting liquid crystal molecules in cholesteric liquid crystal layers. In some embodiments of the invention, screen 500 includes one or more buffer layers disposed between adjacent CLC layers in optical stack 502, such as between CLC layers 500B and 500C.

One or more of the buffer layers and/or CLC layers in screen 500 can be optically diffusive by, for example, dispersing small particles in a host material where the index of refraction of the particles is different than the index of refraction of the host material. Furthermore, one or more of the buffer layers may function as a color filter to, for example, improve color purity of an image displayed by the screen.

Screen 500 further includes one or more diffuser layers such as diffuser layer 540. Diffuser layer 540 can assist in scattering light into a viewing space 570 which may include one or more viewers such as a viewer 595. Diffuser layer 540 can include structures (not shown in FIG. 7) on a side of the layer such as the viewing side 580 for selectively redirecting or further scattering light towards viewing space 570.

Screen 500 further includes a light absorbing layer 550 for increasing screen contrast by absorbing non-imaging or otherwise undesirable light such as ambient light.

Screen 500 may further include other layers not explicitly shown in FIG. 7. Examples include alignment layers for aligning liquid crystal molecules, antireflection coatings, hard coat layers, anti-smudge layers, UV absorbing protective layers, adhesive layers for attaching adjacent layers, one or more backing layers for providing support and/or a desirable shape to the screen, one or more notch filter layers, and the like.

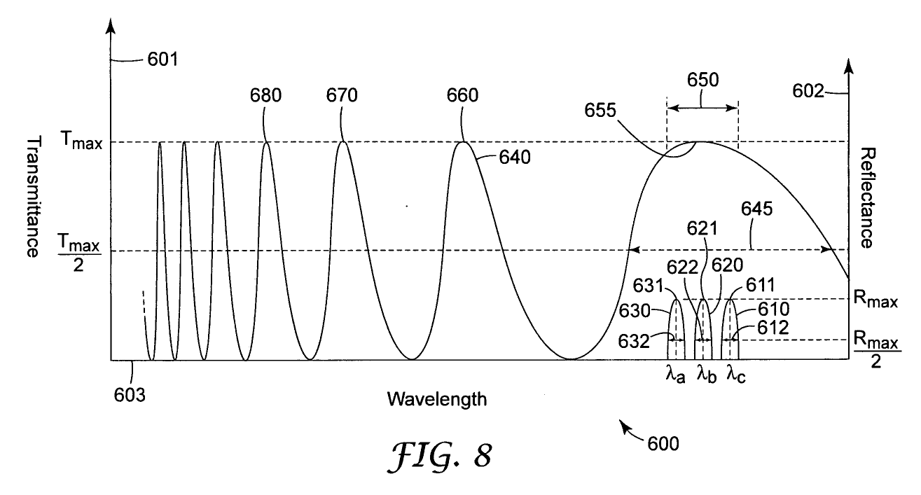

FIG. 8 is a schematic plot 600 showing the relationship between a retardance profile 640 of a retarder layer and the reflectance curves 610, 620, and 630 of CLC layers employed in a front projection screen in accordance with one embodiment of the invention. The screen can, for example, be a front projection screen described in reference to one or more of FIGS. 5-7.

Plot 600 has a vertical transmittance axis 601, a vertical reflectance axis 602, and a horizontal wavelength axis 603. Reflectance curves 610, 620, and 630 illustrate reflectance of the cholesteric liquid crystal layers in the screen. Each reflectance curve is characterized by a reflectance peak and a reflectance full width at half maximum. In particular, curves 610, 620, and 630 have reflectance peaks 611 (located at wavelength λ_{c}), 621 (located at wavelength λ_{b}), and 631 (located at wavelength λₐ), where the peaks are located at different wavelengths. Curves 610, 620, and 630 further have reflectance full width at half maxima (FWHM) 612, 622, and 632, respectively.

In the exemplary embodiment of FIG. 8, reflectance curves 610, 620, and 630 have the same peak reflectance Rₘₐₓ. In general, the reflectance peaks can be different in magnitude for different reflectance curves. Similarly, the reflectance full width at half maximum can be different for different reflectance curves. For example, FWHM 612 can be different than FWHM 622 and/or FWHM 622 can be different than FWHM 632.

Plot 600 also shows retardance profile 640 of a retarder layer employed in the screen. Profile 640 has a plurality of half-wave peaks such as a zeroth order half-wave peak 655, a 1^{st} order half-wave peak 660, a 2^{nd} order half-wave peak 670, and a 3^{rd} order half-wave peak 680. In the exemplary retardance profile 640, each half-wave peak has a height Tₘₐₓ and a half-peak height Tₘₐₓ/2. In general, the height of a half-wave peak in retardance profile 640 may be different for different peaks, for example, due to wavelength dependent absorption losses and/or measurement errors. Furthermore, in general, Rₘₐₓ may be less than, equal to, or greater than Tₘₐₓ. In general, the height of a reflectance peak of a CLC layer can be less than, equal to, or greater than the height of a half-wave peak of a retarder layer.

Retardance profile 640 has an extended half-wave peak area 650, meaning that a retarder layer having retardance profile 640 is substantially a half-wave retarder in extended peak area 650. Area 650 includes reflectance peaks 611, 621, and 631. Accordingly, a retarder layer having a retardance profile similar to profile 640 is substantially a half-wave retarder at reflectance peaks 611, 621, and 631.

Retardance profile 640 further has a retardance full width at half maximum 645 corresponding to peak 655 that encloses the reflectance full width at half maxima 612, 622, and 632.

In plot 600, the reflectance peaks of the cholesteric liquid crystal layers are located substantially at the zeroth order half-wave retardance peak of the retardance profile. In general, the reflectance peak of the CLC layers can be located at a higher order half-wave peak of the retardance profile.

According to one embodiment of the invention, retarder layers in a front projection screen may or may not have the same retardance profile. For example, two or more retarder layers in a front projection screen can have the same retardance profile that is, for example, similar to retardance profile 640. As another example, the retarder layers in a front projection screen can have different retardance profiles, although each retardance profile may have a half-wave retardance peak at the reflectance peak of one or more cholesteric liquid crystal layers in the screen.

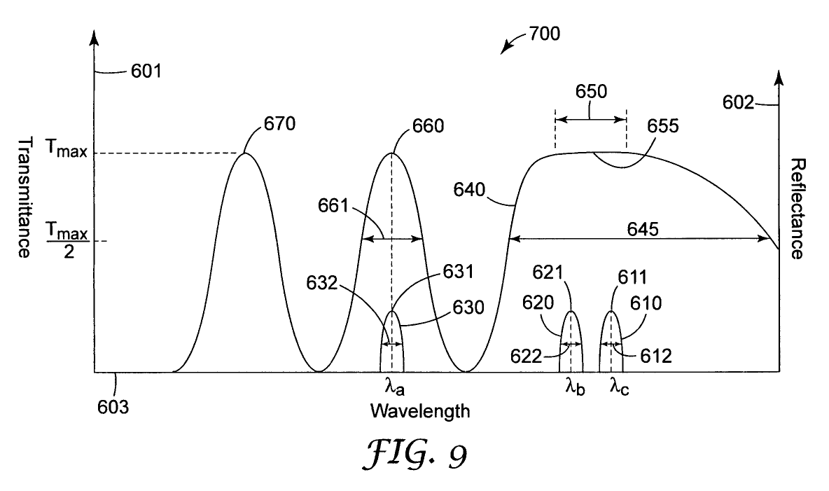

FIG. 9 is a schematic plot 700 showing the relationship between retardance profile 640 of a retarder layer and the reflectance curves 610, 620, and 630 of CLC layers employed in a front projection screen in accordance with another embodiment of the invention. The screen can, for example, be a front projection screen described in reference to one or more of FIGS. 5-7.

In plot 700, reflectance peaks 611 and 621 of respective reflectance curves 610 and 620 are located substantially at the zeroth order half-wave peak 655 of the retardance profile and reflectance peak 631 of reflectance curve 630 is located at a higher order, such as a 1^{st} order, half-wave peak of the retardance profile. According to one embodiment of the invention, retardance FWHM 645 encloses the reflectance full width at half maxima 612 and 622 of respective reflectance curves 610 and 620. Furthermore, retardance FWHM 661 of 1^{st} order half-wave peak 660 encloses the reflectance full width at half maxima 632 of reflectance curve 630.

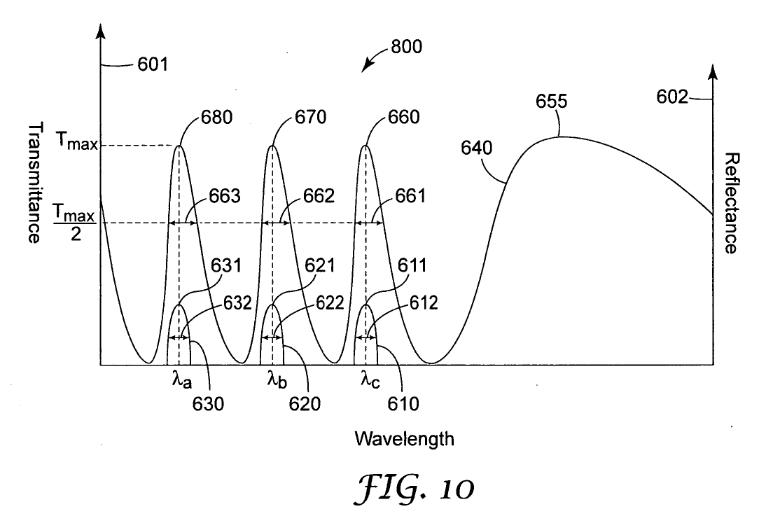

FIG. 10 is a schematic plot 800 showing the relationship between retardance profile 640 of a retarder layer and the reflectance curves 610, 620, and 630 of CLC layers employed in a front projection screen in accordance with another embodiment of the invention. The screen can, for example, be a front projection screen described in reference to one or more of FIGS. 5-7.

In plot 800, reflectance peaks of the CLC layers are located at higher order half-wave peaks of the retardance profiles of one or more retarder layers in the front projection screen. In the exemplary embodiment shown in FIG. 10, reflectance peaks 611, 621, and 631 of respective reflectance curves 610, 620, and 630 are located at 1^{st}, 2^{nd}, and 3^{rd} order half-wave peaks of the retardance profile 640.

In general, the reflectance FWHM 612, 622, and 632, and retardance FWHM 661, 662, and 663 are so designed that the screen reflects one or more desired ranges of wavelengths that may, for example, exclude some of the wavelengths projected by a projector onto the screen. The exclusion my be desirable to improve, for example, the overall color of a projected image. According to one embodiment of the invention, the retardance FWHM of a half-wave peak located at a reflectance peak of a CLC layer encloses the reflectance full width at half maximum of the reflectance peak. For example, in plot 800, retardance FWHM 661 of 1^{st} order half-wave peak 660 encloses the reflectance full width at half maximum 612 of reflectance curve 610, retardance FWHM 662 of 2^{nd} order half-wave peak 670 encloses the reflectance full width at half maximum 622 of reflectance curve 620, and retardance FWHM 663 of 3^{rd} order half-wave peak 680 encloses the reflectance full width at half maximum 632 of reflectance curve 630.

In another embodiment of the invention, the reflectance full width at half maximum 612 of reflectance curve 610 encloses retardance FWHM 661 of 1^{st} order half-wave peak 660, the reflectance full width at half maximum 622 of reflectance curve 620 encloses retardance FWHM 662 of 2^{nd} order half-wave peak 670, and the reflectance full width at half maximum 632 of reflectance curve 630 encloses retardance FWHM 663 of 3^{rd} order half-wave peak 680.

In general, the reflectance peaks can occur at different order half-wave peaks. In one embodiment of the invention, a first reflectance peak occurs at a k1^{th} order half-wave peak, a second reflectance peak occurs at a k2^{th} order half-wave peak where k2 is different than k1, and a third reflectance peak occurs at a k3^{th} order half-wave peak where k3 is different than k1 and k2.

In general, reflectance curves 610, 620, and 630 can be located in one or more desired regions of the electromagnetic spectrum. In one embodiment of the invention, the reflectance curves are located in the visible region of the spectrum.

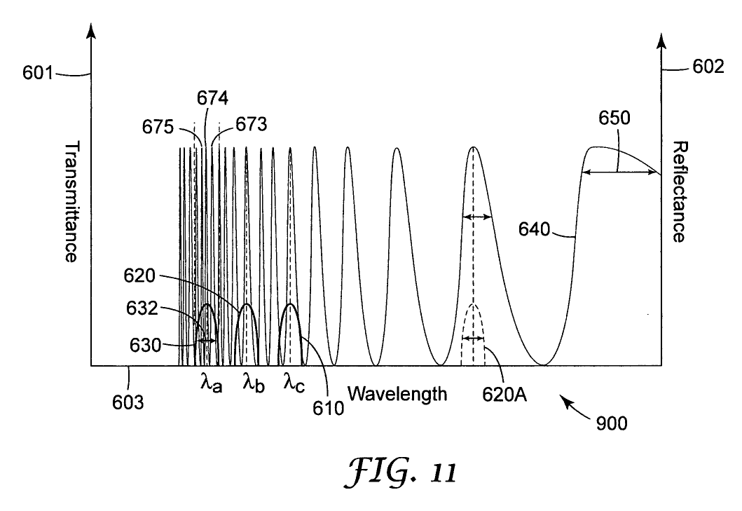

FIG. 11 is a schematic plot 900 showing the relationship between retardance profile 640 of a retarder layer and the reflectance curves 610, 620, and 630 of CLC layers employed in a front projection screen in accordance with another embodiment of the invention. The screen can, for example, be a front projection screen described in reference to one or more of FIGS. 5-7.

In plot 900, retardance profile 640 has a plurality of half-wave retardance peaks enclosed within the reflectance full width at half maximum of a CLC layer. For example, half-wave retardance peaks 673, 674, and 675 of retardance profile 640 are enclosed within reflectance full width at half maximum 632 of reflectance curve 630. According to one embodiment of the invention, the reflectance FWHM of each CLC layer in the screen encloses a plurality of retardance half-wave peaks of one or more retarder layers in the screen.

In one embodiment of the invention, the reflectance peak of a first CLC layer may be located at or near a low order half-wave retardance peak of retardance profile 640 such that the reflectance full width at half maximum of the first CLC layer encloses a single half-wave retardance peak (e.g., reflectance curve 620A), and the reflectance peak of a second CLC layer may be located at or near a high order half-wave retardance peak of retardance profile 640 such that the reflectance full width at half maximum of the second CLC layer encloses a plurality of half-wave retardance peaks (e.g., reflectance curve 630).

Reflectance curves 610, 620, and 630 can, for example, correspond to CLC layers 300A, 300B, and 300C and/or CLC layers 310A, 310B, and 310C of screen 300 shown in FIG. 5, respectively. As another example, curves 610, 620, and 630 can correspond to CLC layers 400A, 400B, and 400C and/or CLC layers 410A, 410B, and 410C of screen 400 shown in FIG. 6, respectively. As yet another example, curves 610, 620, and 630 can correspond to CLC layers 500A, 500B, and 500C and/or CLC layers 510A, 510B, and 510C of screen 500 shown in FIG. 7, respectively.

Retardance profile 640 can, for example, correspond to one or more of retarder layers 320A, 320B, 320C, and 320X in screen 300. As another example, profile 640 can correspond to retarder layer 420 in screen 400. As yet another example, profile 640 can correspond to one or more of retarder layers 520A and 520B in screen 500.

In one embodiment of the invention, in screen 300, CLC layers 300A and 310A have reflectance curves similar to curve 610, CLC layers 300B and 310B have reflectance curves similar to curve 620, and CLC layers 300C and 310C have reflectance curves similar to curve 630. Furthermore, retarder layers 320A, 320B, 320C, and 320X have retardance profiles similar to profile 640.

In another embodiment of the invention, in screen 400, CLC layers 400A and 410A have reflectance curves similar to curve 610, CLC layers 400B and 410B have reflectance curves similar to curve 620, and CLC layers 400C and 410C have reflectance curves similar to curve 630. Furthermore, retarder layer 420 has a retardance profile similar to profile 640.

In another embodiment of the invention, in screen 500, CLC layers 500A and 510A have reflectance curves similar to curve 610, CLC layers 500B and 510B have reflectance curves similar to curve 620, and CLC layers 500C and 510C have reflectance curves similar to curve 630. Furthermore, retarder layers 520A and 520B have retardance profiles similar to profile 640.

FIG. 12 illustrates a schematic side-view of a projection display system 1000 in accordance with one embodiment of the invention. Projection display system 1000 includes a projector 1010 and a front projection screen 1020, where screen 1020 can be a screen in accordance with any embodiment of the present invention.

Projector 1010 has light sources 1001, 1002, and 1003 where the emission spectrum of each light source may include a range of wavelengths in the visible region of the electromagnetic spectrum. In one embodiment of the invention, light source 1001 emits light at a blue primary color, light source 1002 emits light at a green primary color, and light source 1003 emits light at a red primary color.

Screen 1020 has a plurality of cholesteric liquid crystal layers, one or more retarder layers, and a light absorbing layer. The retardance profile of the retarder layers and the reflectance curves of the cholesteric liquid crystal layers are so located along the electromagnetic spectrum that screen 1020 substantially reflects all light projected by projector 1010 and substantially absorbs all light that lies outside the FWHM of the CLC reflectance curves.

Screen 1020 scatters light that is incident on the screen from projector 1010 into a viewing space 1040 that can include one or more viewers such as viewers 1095 and 1096. Furthermore, screen 1020 absorbs a substantial fraction of ambient light 1030 that lies outside the reflectance curves of the cholesteric liquid crystal layers in the screen resulting in a displayed image having high contrast.

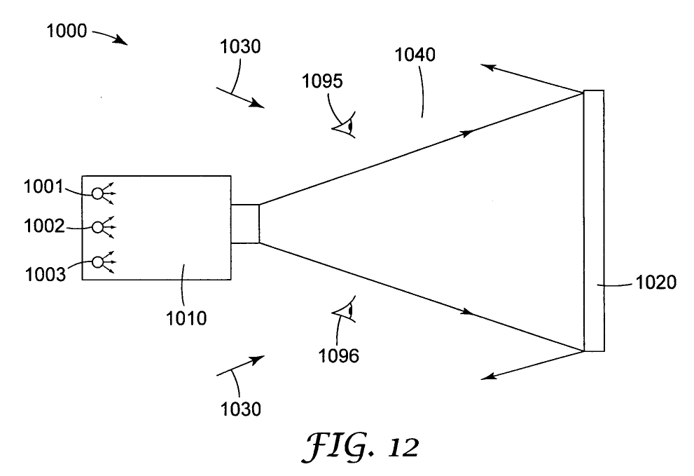

In one embodiment of the invention, the emission spectrum of light projected by projector 1010 substantially matches the reflectance curves of the CLC layers in screen 1020 as shown schematically in FIG. 13. In particular, projector 1010 has an emission spectrum 1301 that is located in the visible region 1380 of the electromagnetic spectrum. Emission spectrum 1301 includes a first emission spectrum such as a blue emission spectrum 1310, a second emission spectrum such as a green emission spectrum 1320, and a third emission spectrum such as a red emission spectrum 1330. Furthermore, the reflectance curves of the CLC layers in screen 1020 include reflectance curves 610, 620, and 630 with reflectance FWHM 612, 622, and 632, respectively. According to one embodiment of the invention, FWHM 612 encloses a substantial portion of emission spectrum 1330, FWHM 622 encloses a substantial portion of emission spectrum 1320, and FWHM 632 encloses a substantial portion of emission spectrum 1310. Accordingly, screen 1020 reflects substantially all light emitted by projector 1010 while any light, such as ambient light 1030, that lies outside the reflectance curves of the CLC layers, is substantially absorbed by the light absorbing layer in screen 1020.

In the exemplary embodiment shown in FIG. 12, projector 1010 is shown to include three light sources. In general, projector 1010 may have more or fewer light sources. For example, in some applications, projector 1010 may include a single light source that emits light in the blue, green, and red regions of the electromagnetic spectrum. In some other applications, one or more of light sources 1001, 1002, and 1003 may include a plurality of light sources, such as light emitting diodes (LEDs).

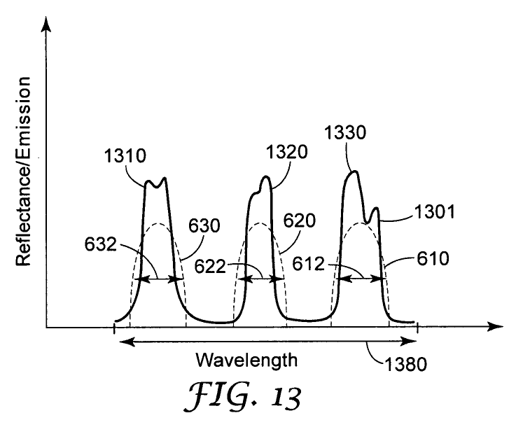

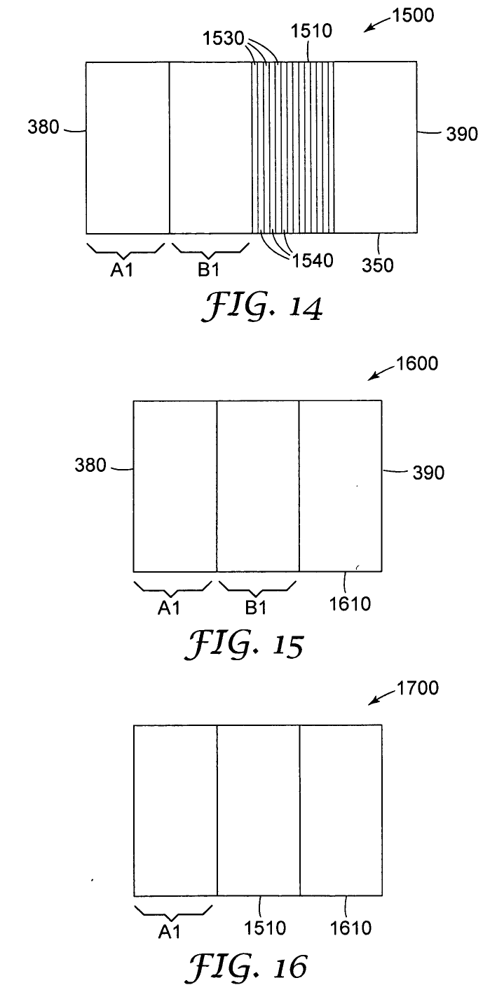

FIG. 14 illustrates a schematic side-view of a front projection screen 1500 in accordance with one embodiment of the invention. Screen 1500 is similar to screen 300 having optical stacks A1, B1, and C1, and light absorbing layer 350, except that optical stack C1 in FIG. 5 is replaced with a multilayer optical film (MOF) 1510. MOF 1510 functions similarly to optical stack C1. For example, in some embodiments of the invention, MOF 1510 substantially reflects light within the wavelength range Δλ_{C1} in the visible and substantially transmits light elsewhere in the visible.

MOF 1510 includes alternating layers 1530 and 1540 where the alternating layers have different indices of refraction. MOF 1510 reflects light by optical interference. The term optical interference, as used herein, means that an incoherent analysis is generally not adequate to sufficiently predict or describe all the reflective properties of a layer that reflects light by optical interference in a desired region of the spectrum. In one embodiment of the invention each of alternating layers 1530 and 1540 reflects light by optical interference. Multilayer optical films have been discussed in, for example, U.S. Pat. Nos. 3,610,729; 4,446,305; 4,540,623; 5,448,404; and 5,882,774.

FIG. 15 illustrates a schematic side-view of a front projection screen 1600 in accordance with one embodiment of the invention. Screen 1600 is similar to screen 300 having optical stacks A1, B1, and C1, and light absorbing layer 350, except that optical stack C1 and light absorbing layer 350 in FIG. S are replaced with a colored reflective layer 1610 that substantially reflects light in a wavelength region and substantially absorbs light in a different wavelength region. In one embodiment of the invention, colored reflective layer 1610 substantially reflects light within the wavelength range Δλ_{C1} in the visible and substantially absorbs light elsewhere in the visible. Δλ_{C1} can be a reflectance FWHM of colored reflective layer 1610 and can, for example, be a blue, a green, or a red wavelength range in the visible.

Colored reflective layer 1610 can be any reflective layer that reflects light in one wavelength region and absorbs light in other regions. For example, colored reflective layer 1610 can be made by dispersing a colorant such as a pigment and/or a dye in a binder. The light absorbing properties of colored reflective layer 1610 eliminates or reduces the need for a separate light absorbing layer in screen 1600. Colored reflective layer 1610 is preferably disposed in back side 390 of screen 1600.

FIG. 16 illustrates a schematic side-view of a front projection screen 1700 in accordance with one embodiment of the invention. Screen 1700 is similar to screen 300 having optical stacks A1, B1, and C1, and light absorbing layer 350, except that optical stack B1 in FIG. 5 is replaced with MOF 1510, and optical stack C1 and light absorbing layer 350 are replaced with colored reflective layer 1610. In one embodiment of the invention, optical stack A1 substantially reflects light within Δλ_{A1} in the visible and substantially transmits light elsewhere in the visible; MOF 1510 substantially reflects light within Δλ_{B1} in the visible and substantially transmits light elsewhere in the visible; and colored reflective layer 1610 substantially reflects light within Δλ_{C1} in the visible and substantially absorbs light elsewhere in the visible.

In one embodiment of the invention, Δλ_{A1} is a wavelength range that includes a first primary color such a blue color, Δλ_{B1} is a wavelength range that includes a second primary color such a green color, and Δλ_{C1} is a wavelength range that includes a third primary color such a red color.

### EXAMPLE

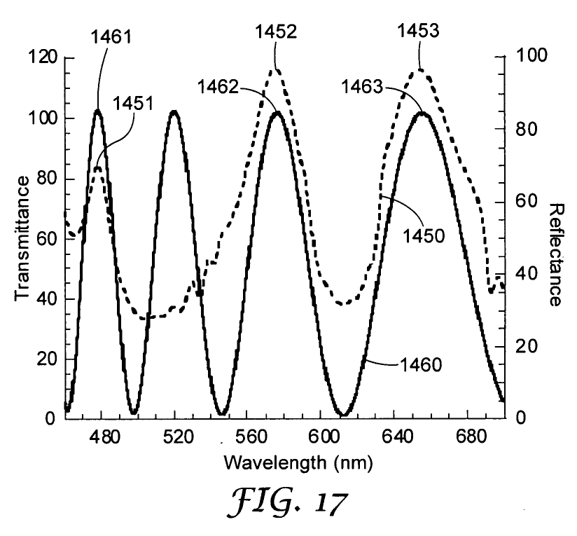

Advantages and embodiments of the present invention are further illustrated by the following example. The particular materials, amounts and dimensions recited in this example, as well as other conditions and details, should not be construed to unduly limit the present invention. A front projection screen similar to screen 300 of FIG. 5 having three optical stacks A1, B1, and C1 was prepared as follows. A 96 micron thick 3M Scotchpak polyester film (available commercially from 3M Co., Maplewood, Minn.) was used as the retarder layer in each of the three optical stacks. The retarder layer had a retardance profile 1460 shown in FIG. 17.

Optical stack A1 was prepared by coating both sides of a Scotchpak film with a solution containing a nematic liquid crystalline monomer LC756 commercially available from BASF AG, Ludwigshafen, Germany, a chiral dopant LC242 also commercially available from BASF AG, and a photoinitiator (Irgacure 819 commercially available from Ciba Specialty Chemicals, Tarrytown, N.Y.) where the weight ratio of LC242 to LC756 was approximately 23.6 resulting in a reflectance curve located in the red region of the spectrum with a reflectance peak at about 654 nm. The coated assembly was cured and cross-linked by exposure to UV radiation. Optical stacks B1 and C1 were similarly prepared except that in the case of optical stack B1, the weight ratio was approximately 20.8 resulting in a reflectance curve located in the green region of the spectrum with a reflectance peak at about 575 nm, and in the case of optical stack C1, the weight ratio was approximately 16.9 resulting in a reflectance curve located in the blue region of the spectrum with a reflectance peak at about 479 nm.

Next, the three optical stacks were arranged similar to the arrangement shown in FIG. 5. The neighboring stacks were laminated to each other using optical adhesive 3M 8141 available commercially from 3M Co. The resulting assembly had a reflectance curve 1450 that included reflectance peaks 1451, 1452, and 1453 in the blue, green, and red regions of the electromagnetic spectrum, respectively. Retardance profile 1460 shows that retardance half-wave peak 1463 was located near reflectance peak 1453, retardance half-wave peak 1462 was located near reflectance peak 1452, and retardance half-wave peak 1461 was located near reflectance peak 1451. Accordingly, the retarder layers in the three optical stacks were substantially half-wave retarders at the reflectance peaks of the CLC layers in the screen.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A front projection screen comprising a plurality of cholesteric liquid crystal layers and one or more retarder layers, each cholesteric liquid crystal layer having a reflectance curve characterized by a reflectance peak and a reflectance full width at half maximum, the reflectance peaks of at least two cholesteric liquid crystal layers in the plurality of cholesteric liquid crystal layers being at different wavelengths, wherein a retardance full width at half maximum of a first retarder layer in the one or more retarder layers encloses the reflectance full width at half maxima of two or more cholesteric liquid crystal layers in the plurality of cholesteric liquid crystal layers.

2. The front projection screen of claim 1, wherein the retardance full width at half maximum of the first retarder layer encloses the reflectance full width at half maxima of the cholesteric liquid crystal layers in the plurality of cholesteric liquid crystal layers

3. The front projection screen of claim 1, wherein the first retarder layer is substantially a half-wave retarder at the reflectance peaks of the cholesteric liquid crystal layers in the plurality of cholesteric liquid crystal layers.

4. The front projection screen of claim 1, wherein the one or more retarder films have substantially a same retardance profile.

5. The front projection screen of claim 1, wherein the reflectance peaks of the plurality of the cholesteric liquid crystal layers are located at three or more distinct wavelengths.

6. The front projection screen of claim 1 further comprising a light absorbing layer.

7. The front projection screen of claim 1 further comprising a light diffusing layer.

8. The front projection screen of claim 1, wherein at least one of the plurality of cholesteric liquid crystal layers is optically diffusive.

9. A front projection screen comprising a plurality of cholesteric liquid crystal layers and one or more retarder layers, a first cholesteric liquid crystal layer in the plurality of cholesteric liquid crystal layers having a first reflectance peak at an m^{th} order half-wave retardance peak of a retarder layer in the one or more retarder layers, a second cholesteric liquid crystal layer in the plurality of cholesteric liquid crystal layers having a second reflectance peak at an n^{th} order half-wave retardance peak of a retarder layer in the one or more retarder layers, the first reflectance peak being at a different wavelength than the second reflectance peak, n being different than m.

10. The front projection screen of claim 9, wherein the m^{th} and n^{th} order half-wave retardance peaks are from a same retarder layer.

11. The front projection screen of claim 9, wherein at least one of the m^{th} and n^{th} orders is higher than a zeroth order.

12. The front projection screen of claim 9, wherein a retardance full width at half maximum of the m^{th} order half-wave retardance peak encloses a reflectance full width at half maximum of the first reflectance peak.

13. The front projection screen of claim 9, wherein a retardance full width at half maximum of the n^{th} order half-wave retardance peak encloses a reflectance full width at half maximum of the second reflectance peak

14. The front projection screen of claim 9, wherein the plurality of cholesteric liquid crystal layers have a same handedness.

15. The front projection screen of claim 9, wherein at least two cholesteric liquid crystal layers in the plurality of cholesteric liquid crystal layers have reflectance peaks at substantially a same wavelength.

16. The front projection screen of claim 9 further comprising a light absorbing layer.

17. A front projection display comprising a projector and the front projection screen of claim 1, the projector being capable of projecting an image at a plurality of distinct wavelength ranges, the plurality of cholesteric liquid crystal layers having reflectance peaks within each of the plurality of distinct wavelength ranges.

18. The front projection display of claim 17, wherein the plurality of distinct wavelength ranges includes wavelength ranges in the blue, green, and red regions of the electromagnetic spectrum.

19. A front projection screen comprising a plurality of cholesteric liquid crystal layers and one or more retarder layer, each cholesteric liquid crystal layer having a reflectance curve characterized by a reflectance peak and a reflectance full width at half maximum, at least one of the one or more retarder layers having a plurality of half-wave retardance peaks within the reflectance full width at half maximum of a cholesteric liquid crystal layer in the plurality of cholesteric liquid crystal layers.

20. The front projection screen of claim 19, wherein the reflectance peaks of the plurality of the cholesteric liquid crystal layers are located at three or more distinct wavelengths.

21. A front projection display comprising a projector and the front projection screen of claim 19, the projector being capable of projecting an image at a plurality of distinct wavelength ranges, the plurality of cholesteric liquid crystal layers having reflectance peaks within each of the plurality of distinct wavelength ranges.

22. A front projection screen comprising at least three groups of optical layers, each group including a retarder layer disposed between two cholesteric liquid crystal layers having a same handed-ness, each group reflecting light in a wavelength region in which the other groups transmit light.

23. The front projection screen of claim 22, wherein the reflectance peaks of the two cholesteric liquid crystal layers in a group of optical layers are located at substantially a same wavelength.

24. The front projection screen of claim 22, wherein the retarder in each group is substantially a half-wave retarder at the reflectance peaks of the two cholesteric liquid crystal layers in the group.

25. The front projection screen of claim 22, wherein at least one group of optical layers forms a stack of the optical layers.

26. The front projection screen of claim 22, wherein a first group in the at least three groups of optical layers reflects light in a blue region of the electromagnetic spectrum and transmits light elsewhere in the visible, a second group in the at least three groups of optical layers reflects light in a green region of the electromagnetic spectrum and transmits light elsewhere in the visible, and a third group in the at least three groups of optical layers reflects light in a red region of the electromagnetic spectrum and transmits light elsewhere in the visible.

27. The front projection screen of claim 22, wherein a cholesteric liquid crystal layer in a group is optically diffusive.

28. The front projection screen of claim 22 further comprising a light absorbing layer.

29. The front projection screen of claim 22, wherein in a group of optical layers each of the two cholesteric liquid crystal layers has a reflectance curve characterized by a reflectance peak and a reflectance full width at half maximum, and wherein the retarder layer in the group has a plurality of half-wave retardance peaks within the reflectance full width at half maximum of each of the two cholesteric liquid crystal layers.

30. The front projection screen of claim 22, wherein in a group of the at least three groups of optical layers each of the two cholesteric liquid crystal layers has a reflectance curve characterized by a reflectance peak and a reflectance full width at half maximum, and wherein the retarder layer in the group has a retardance profile characterized by a plurality of half-wave retardance peaks, each retardance peak having a corresponding retardance full width at half maximum, and wherein the reflectance full width at half maximum of each cholesteric liquid crystal layer in the group is enclosed within a retardance full width at half maximum of the retarder layer in the group.

31. The front projection screen of claim 22, wherein a retarder layer in a group comprises a multilayer optical film capable of reflecting light by optical interference, wherein the multilayer optical film comprises alternating first and second layers.

32. A front projection screen comprising at least three groups of optical layers, each group reflecting light in a wavelength region in which the other groups transmit light, each of at least two groups including a retarder layer disposed between two cholesteric liquid crystal layers having a same handed-ness, at least one group including a multilayer optical film comprising alternating first and second layers, wherein the multilayer optical film reflects light by optical interference.

33. A front projection screen comprising:
a first group of optical layers substantially reflecting light in a first wavelength region in the visible and substantially transmitting light elsewhere in the visible;
a second group of optical layers substantially reflecting light in a second wavelength region in the visible and substantially transmitting light elsewhere in the visible, the second region being different than the first region, each of the first and second groups including a retarder layer disposed between two cholesteric liquid crystal layers having a same handed-ness; and
a colored reflective layer substantially reflecting light in a third wavelength region in the visible and substantially absorbing light elsewhere in the visible, the third region being different than the first and the second regions.

34. The front projection screen of claim 33, wherein the colored reflective layer comprises pigments and/or dyes dispersed in a binder.
